(19) United States
(12) Patent Application Publication
(10) Pub. No.: US 2013/0096244 A1
(43) Pub. Date: Apr. 18, 2013

(54) WATER-BASED LIQUID COLOR CONTAINING THERMOSTABLE DISPERSION ADDITIVES FOR THE COLORING POLY(METH)ACRYLATES

(71) Applicants: Sabine Schwarz-Barac, Riedstadt (DE); Roger Recktenwald, Bensheim (DE); Thorsten Goldacker, Rossdorf (DE); Ursula Golchert, Dieburg (DE); Victor Khrenov, Frankfurt (DE); Stefan Nau, Buettelborn (DE); Nils Mehler, Brensbach (DE); Krzysztof Sado, Weiterstadt (DE); Ernst Becker, Bensheim (DE); Norbert Bendzko, Leverkusen (DE); Joachim Henn, Marienheide (DE); Markus Vogt, Koeln (DE); Markus Schubert, Lohmar (DE); Daniel Cleff, Bad Arolsen (DE); Birgit Riedel-Bendzko, Leverkusen (DE)

(72) Inventors: Sabine Schwarz-Barac, Riedstadt (DE); Roger Recktenwald, Bensheim (DE); Thorsten Goldacker, Rossdorf (DE); Ursula Golchert, Dieburg (DE); Victor Khrenov, Frankfurt (DE); Stefan Nau, Buettelborn (DE); Nils Mehler, Brensbach (DE); Krzysztof Sado, Weiterstadt (DE); Ernst Becker, Bensheim (DE); Norbert Bendzko, Leverkusen (DE); Joachim Henn, Marienheide (DE); Markus Vogt, Koeln (DE); Markus Schubert, Lohmar (DE); Daniel Cleff, Bad Arolsen (DE); Birgit Riedel-Bendzko, Leverkusen (DE)

(73) Assignee: Evonik Roehm GmbH, Darmstadt (DE)

(21) Appl. No.: 13/806,322

(22) PCT Filed: Jul. 5, 2011
(86) PCT No.: PCT/EP11/61303

§ 371 Date: Dec. 21, 2012

(30) Foreign Application Priority Data
Jul. 9, 2010 (DE) 10-2010-031-183.9

(51) Int. Cl. C08L 33/10

(52) U.S. Cl. CPC C08L 33/10
USPC 524/190; 264/328.18

(57) ABSTRACT

The invention relates to a method for coloring thermoplastic molding compounds, preferably a polymethyl(meth)acrylate molding compound, using novel aqueous colorant preparations. The invention further relates to a novel water-based colorant preparation.

The invention relates to a process for colouring thermoplastic polymer moulding materials, preferably a polymethyl (meth)acrylate moulding material, with novel aqueous colorant preparations. The invention further relates to novel water-based colorant preparations.

Colorant preparations for colouring plastics articles are known.

For instance, U.S. Pat. No. 3,956,008 describes a liquid dispersion for colouring plastics articles, consisting of inorganic particles between 2 and 50 μm in size and a surface-active system composed of sorbitol esters. Aqueous systems are not described.

U.S. Pat. No. 3,992,343 describes an aqueous dispersion system consisting of organic or inorganic pigment particles, water and a dispersant, the dispersant being very specific.

U.S. Pat. No. 4,091,034 describes a blue, water-soluble dye formulation of a triphenylmethane dye. As an aqueous dispersion, it is used to colour textiles.

U.S. Pat. No. 4,167,503 describes a liquid formulation based on a carrier formed from a polyoxyethylene derivative, PEG and a further additive. Water as a solvent is not used.

U.S. Pat. No. 4,169,203 describes water-soluble, polymeric pigments which consist of a nonchromophoric polymeric structure and chromophoric groups chemically bonded thereto.

U.S. Pat. No. 4,341,565 describes a liquid dye formulation composed of solid pigment, a liquid phase composed of esters of long-chain alcohols and long-chain acids, and a gellating aid.

U.S. Pat. No. 4,871,416 likewise describes organic-based formulations.

U.S. Pat. No. 4,634,471 describes formulations comprising organic solvents.

U.S. Pat. No. 4,804,719 describes a water-dispersible formulation comprising a polymer.

U.S. Pat. No. 4,910,236 describes a printing ink formed from an aqueous emulsion of water and emulsifier, and an organic phase formed from olefinic resins and pigment. In a subsequent step, the water is withdrawn from the formulation.

U.S. Pat. No. 5,043,376 describes a nonaqueous system.

U.S. Pat. No. 5,104,913 is a divisional application of U.S.-A'376 and describes a process for producing an aqueous dye dispersion, oil in water.

U.S. Pat. No. 5,308,395 likewise describes an organic solution.

A hydrophilic colorant and water are formed in U.S. Pat. No. 5,328,506 to a paste, which can be further processed with the customary tools and machines in dye production.

U.S. Pat. No. 5,759,472 describes a process for forming polymers, consisting of the following steps: production of a colour mixture from a carrier (10-75%), water (0-15%), a dispersant (0.1-10%) and a colorant (10-80%). In addition, polyols may also be present. In a further process step, a pulverulent polymer is provided, then the carrier system is mixed with the polymer powder and processed to give the mixture (PE). A dependent claim is directed to the amount of 1-14% water.

U.S. Pat. No. 6,428,733 describes a volatile system; it comprises a mixture of glycerol and water.

U.S. Pat. No. 6,649,122 describes a process for colouring thermoplastic polymers, in which 10 to 80 percent colorant and not more than 30 percent dispersant are used; the remainder is water as a solvent. The dispersants used are polyvinylpyrrolidones, for example Sokolan® HP50 (BASF) or neutralized polyacrylic acids, salts of lignosulphonic acids, of naphthalenesulphonic acids or of polymeric carboxylic acids. Preference is given to using nonionic dispersants, for example nonylphenol or octylphenol.

A disadvantage of the abovementioned solutions of the prior art is the more or less intensive use of organic solvents in the colorant formulation.

The use of organic solvents in polymer moulding materials leads to a rise in the concentration of low molecular weight organic compounds in the polymer, and hence to a deterioration in the properties of the polymers, for example lowering of the Vicat softening temperature, or to a higher stress cracking sensitivity of the articles produced from the polymers.

The liquid colours obtainable on the market generally comprise fatty acid esters or white oils as binders, which remain in the polymer after colouring and lead to a lowering of the Vicat softening temperature. In addition, deposit formation can be observed in injection moulding.

A new approach to the production of water-based colorant preparations for thermoplastic polymer moulding materials is disclosed by WO 2010/020474 A1. However, the colorant preparations disclosed therein have the disadvantage that the moulding materials coloured therewith can yellow in the event of high or long-lasting thermal stress.

It is therefore an object of the present invention to provide an aqueous colorant preparation and a process for colouring thermoplastic polymer moulding materials, which has the disadvantages of the prior art outlined above only to a reduced degree, if at all, and which can be used as a problem-free substitute for the colouring of thermoplastic polymer moulding materials. A specific object is to provide colorant preparations and a process for colouring thermoplastic polymer moulding materials, which ensure that moulding materials coloured therewith exhibit only a slight increase in yellowness index even under thermal stress.

In a further specific object, the inventive colorant preparation should be universally variable, i.e. pigmentable both with organic and inorganic pigments.

In yet a further object, the inventive colorant preparation should contribute to lower colour locus variations in the coloured moulding materials than in the case of the prior art colorant preparations.

Further objects which are not stated explicitly are evident from the overall context of the description, examples and claims which follow.

The inventors have now found that, surprisingly, in the case of use of dispersing aids which, in the dried state, have a mass loss of not more than 15% by weight in isothermal thermogravimetric analysis at 260° C. for 60 min, it is possible to produce aqueous colorant preparations which allow colouring of thermoplastic moulding materials such that they yellow only to a very minor degree, if at all, even in the course of prolonged and/or relatively severe thermal stress, and have very low colour locus variations.

Without being bound to a particular theory, the inventors are of the view that the specific dispersing additives used in accordance with the invention, by virtue of being less severely pyrolysed in the course of prolonged and/or relatively severe thermal stress, form a lower level of short-chain carbon fragments, and thus contribute to a lesser degree to yellowing. It has thus been possible for the first time with the present invention to produce thermoplastic moulding materials coloured directly with water-based liquid colour, which can be extruded at high temperatures or exposed to high thermal stresses over a prolonged period.

The present invention therefore provides aqueous colorant preparations according to Claim 1, coloured moulding materials or thermoplastic polymers according to any of Claims 8, 9, 13 or 14, and a process for colouring thermoplastic polymers according to Claim 10.

Further preferred subject-matter of the present invention is evident from the description which follows, the examples and the dependent claims.

The present invention is described in detail hereinafter.

The invention relates to an aqueous colorant preparation for colouring of thermoplastic polymer moulding materials,

characterized in that it comprises
a) 1% by weight to 49% by weight, preferably 5% by weight to 45% by weight, more preferably 10% by weight to 40% by weight, of a dispersing additive which has a mass loss of not more than 15% by weight in isothermal thermogravimetric analysis at 260° C. for 60 min,
b) 0.5% by weight to 50% by weight of a pigment or of a pigment mixture and
c) 0% by weight to 50% by weight of assistants, and
d) 0% by weight to 98.5% by weight of water, preferably demineralized water,
   where the portions by weight of components a) to d) add up to 100% by weight. The water in component d) should be considered independently of any water introduced via component a). In component a), the dispersing additive can be introduced in pure form or else as an aqueous solution.

It has been found that moulding materials of thermoplastic polymers, when coloured with colorant preparations according to WO 2010/020474, can yellow to too high a degree under high and/or long thermal stress, for example injection moulding at 290° C. (colour locus shift). The inventors have identified the cause to be the dispersing aid EFKA 4550 from Ciba. It has been found, for example, that the thermal stress of a pure EFKA 4550 compound (only standard moulding material with addition of EFKA 4550 without other constituents of the colorant preparation) leads to a great increase in yellowness index.

By virtue of the use of the inventive aqueous colorant preparation, it is possible in a surprising and unexpected manner to solve these problems with the yellowing, but at the same time also to ensure that, in addition to good colouring of the thermoplastic polymer moulding material, it is also possible to achieve constancy or even an increase in the Vicat softening temperature of the polymer moulding produced from the coloured thermoplastic polymer moulding material. The other mechanical properties of the polymer mouldings remain unchanged.

The use of the inventive colorant preparations with the specific dispersing additive(s) allows problem-free use for the continuous colouring of thermoplastic polymer moulding materials.

In spite of the improved effects found on the yellowness index, it has been found, surprisingly, that the specific dispersing additives used, with a mass loss of not more than 15% by weight in isothermal thermogravimetric analysis at 260° C. for 60 min, are still capable of sufficiently stabilizing the colorants in the aqueous phase and of preventing the agglomeration and resulting sedimentation of the colorants.

According to the invention, a dispersing additive is used with a mass loss in the dried state of not more than 15% by weight, preferably 0.1 to 10% by weight, more preferably 0.5 to 7% by weight, even more preferably 0.5 to 5% by weight and especially preferably 1 to 4% by weight in isothermal thermo-gravimetric analysis at 260° C. for 60 min.

Suitable commercially available examples thereof are Tego® Dispers 750 W and 755W from Evonik Goldschmidt GmbH and Disperbyk® 190 from Byk-Chemie. Tego® Dispers 755W is traded, for example, as a polymeric, solvent-free wetting and dispersing additive as a 40% solution.

It may also be preferable to use, for example, those dispersants as described in EP 1 026 178 B1, which is hereby incorporated explicitly into the description of the present application. Especially the high molecular weight copolymers which are described in the preparation example therein and comprise at least maleic anhydride, styrene and an amino polyether as monomer units can be used in accordance with the invention as dispersants. Dispersants used with preference have a (weight-)average molecular weight of 20 000 to 50 000 g/mol.

In a further preferred embodiment, an aqueous alkaline solution of a copolymer of methacrylic acid with hydrophobic methacrylate is used as a dispersing additive. It is prepared from a suspension polymer of the abovementioned composition by alkaline hydrolysis (pH 12). The solids content of the aqueous alkaline solution may vary between 0.1 and 10% by weight; the solids content is preferably 2 to 6% by weight, more preferably 3 to 5% by weight.

It is likewise possible with preference to use copolymers of polyethers, preferably ethylene oxide, propylene oxide and/or butylene oxide, and styrene oxide. Examples thereof can be found in the Tego®Dispers 65X range, preferably Tego® Dispers 650, Tego® Dispers 651 and Tego® Dispers 655, which are sold by Evonik Goldschmidt GmbH.

The amount of the particular inventive dispersing additive may preferably be between 5% by weight and 45% by weight, based on the total amount of the colorant preparation; the concentration of the particular dispersing additive is preferably 10% by weight to 40% by weight and more preferably 20% by weight to 35% by weight, based in each case on the total amount of the colorant preparation. Again, it should be noted here that the dispersing additive may be a dilute solution. The figure in percent by weight then relates to the total mass of the diluted solution in each case and not to the active substance content.

As pigments or the pigment mixture, it is possible to use the following colorant groups according to the inventive teaching:
1. organic colour pigments, for example diazo dyes, phthalocyanines, perylenes, anthraquinones,
2. organic soluble dyes, for example anthrapyrimidines, quinophthalone, perinones, or monoazo dyes, for example Thermoplast Red® 454, Macrolex Yellow® G, Sandoplast® Red G or Solvaperm®Red G,
3. mixture of 1 and 2,
4. inorganic pigments (for example zinc chromate, cadmium sulphide, chromium oxide, ultramarine pigments and metal flakes, and also BaSO₄ and TiO₂)
5. mixture of 1, 2 and 4, and
6. carbon black.

The amount of colorant may be between 0.5% by weight and 50% by weight, based on the total amount of the colorant preparation.

Optionally, all customary assistants may be added to the inventive colorant preparation, for example agents to prevent decay or bacterial decomposition, fungicides, levelling agents, thickeners and defoamers. Here, for example, the defoamer Byk 024 from Byk Chemie and, for example, the antibactericides Ebotec MT 15, Acticide MBL or Acticide IPW50 are used.

To establish the optimal viscosity of the colorant composition, if a reduction in the viscosity is necessary, preference is given to using water, particular preference to using demineralized water.

In the case of a low concentration of the pigments or pigment mixtures in the colorant preparation, especially in the case of concentrations of less than 10% by weight, an adjustment of the viscosity may be necessary in order to prevent sedimentation of the pigments or pigment mixtures, which is preferably done by adding one or more thickeners. The thickeners preferred in accordance with the invention should adversely affect neither the thermal stability nor the weathering results of the coloured moulding materials.

Suitable thickeners are celluloses, especially ethylcellulose.

Preferred thickeners for establishment of the desired viscosity of the colorant preparation are carboxylate-containing polymers, which are available as water- or alkali-soluble solid products, as colloidal solutions or as aqueous dispersions, for example homo- and copolymers based on vinyl acetate and crotonic acid or partly hydrolysed poly(meth)acrylates. Particular preference is given to homo- and copolymers of acrylic acid and/or methacrylic acid in the form of the sodium salts thereof.

In the pure acid form, carboxyl-containing polymers are water-insoluble and have to be put into a state of solvation suitable for coacervation. For this purpose, a sufficient portion of the carboxyl groups must be present in the form of carboxylate groups. They bring about the solvation of the polymer with water, such that it is present in the truly dissolved or at least in the colloidally dissolved state. True solutions are substantially clear. Colloidal solutions are notable for greater or lesser turbidity. If the polymer contains as yet unneutralized carboxyl groups, a colloidal, slightly turbid solution can be converted to a true solution by further neutralization.

The state of solvation required is achieved by a sufficient content of carboxylate groups in the polymer. In the case of polymers with a high carboxyl group content, even partial neutralization of the carboxyl groups to carboxylate groups is sometimes sufficient, while complete neutralization is usually necessary in the case of copolymers with a low carboxyl group content.

If the carboxyl group content is too low, sufficient solvation cannot be achieved even in the case of complete neutralization.

The carboxylate content required for sufficient solvation depends on the hydrophilicity of the overall polymer. It is generally in the range from 3 to 10% by weight, calculated as COO— and based on the weight of the unneutralized polymer. If the polymer is formed completely or predominantly from units of an ethylenically unsaturated, free-radically polymerizable carboxylic acid, complete neutralization is advantageous but not essential. According to the degree of neutralization, the pH of the thickeners is preferably in the range from 8 to 11.

For neutralization of the carboxyl to carboxylate groups, any base containing monovalent cations is suitable in principle. Aqueous alkali, especially sodium hydroxide solution, is preferred for economic reasons.

The proportion of the ethylenically unsaturated, free-radically polymerizable carboxylic acid should preferably be not less than 6 and not more 80% by weight, preferably 10 to 80% by weight, especially 20 to 80% by weight, based on the total weight of the monomers used to prepare the thickeners. Acrylic acid and/or methacrylic acid, and also maleic acid, are preferred; additionally suitable are fumaric acid, itaconic acid or crotonic acid.

The comonomers involved in the formation of the polymer may be ethylenically unsaturated, free-radically polymerizable monomers of high or low water solubility. An advantageous effect is possessed by ethylene and alkyl esters of acrylic acid and/or methacrylic acid, especially having 1 to 4 carbon atoms in the alkyl radical.

The proportion thereof is preferably 20 to 90% by weight, more preferably 20 to 80% by weight, based on the total weight of the monomers used for preparation of the thickeners. Other useable comonomers are, for example, styrene, acrylonitrile or vinyl acetate. Comonomers which have higher hydrophilicity or are water-soluble, such as acrylamide and/or methacrylamide or hydroxyalkyl esters of acrylic acid and/or methacrylic acid, may also be used, for example, in proportions totalling about 30% by weight, preferably up to 10% by weight, based on the total weight of the monomers used to prepare the thickeners.

Finally, it is also possible for small proportions of crosslinking comonomers having two or more ethylenically unsaturated, free-radically polymerizable groups in the molecule, such as ethylene glycol diacrylate and dimethacrylate, allyl acrylate and methacrylate, to be involved in the formation of the polymer. However, the proportion thereof must be low enough to still permit sufficient solvation, for example up to 3, preferably up to 1, and especially up to 0.1% by weight, based on the total weight of the monomers used for preparation of the thickeners.

A satisfactory effect as a thickener generally requires a sufficient molecular weight of the polymer. It should generally be at least 20 000, preferably 50 000 to 2 million, determined in each case as the weight average. Preferred carboxylate-containing thickeners have, in the form of an aqueous solution adjusted to pH 9 with sodium hydroxide solution, at a concentration of 200 g/l and 20° C., a viscosity of more than 100 and especially more than 1000 mPas. This viscosity is achieved by very high molecular weight thickeners at a concentration of only about 30 g/1.

Thickeners used with particular preference in the context of the present invention are commercially available as Rohagit S from Evonik Röhm GmbH. Rohagit S is a bead polymer based on methacrylic acid. The acid number is reported as 390-440 mg KOH/g. According to the molecular weight of the bead polymer to be used, it is thus possible to produce a high-viscosity thickener solution (Rohagit S hV) or a medium-viscosity thickener solution (Rohagit S mV). The viscosity of aqueous solutions depends on the solids content, the temperature, the degree of neutralization and the type of base used for neutralization. The viscosity of a 3% Rohagit S solution as the sodium salt at 20° C. is, for example, 3800-5500 mPas for Rohagit S mV (Brookfield viscosimeter, LVT), and 7700-11000 mPas for Rohagit S hV. The minimum concentration recommended is a 3% solution of Rohagit S.

The addition of one or more thickeners may precede the actual dispersion of the pigments or pigment mixture and of the dispersing additive with the aid of shear, or else follow the dispersion of the pigments or pigment mixture and of the dispersing additive.

The thermoplastic polymer moulding material can be coloured either directly by addition of the colorant preparation to an uncoloured polymer moulding material, or via a masterbatch.

A masterbatch is understood to mean a formulation of the colorant preparation and a polymer moulding material, the concentration of the colorant preparation in the masterbatch being adjusted such that the desired colour impression arises when the masterbatch is used to colour uncoloured polymer moulding materials.

According to the invention, thermoplastic polymers are coloured. The thermoplastic polymer moulding material used is, for example, a poly(alkyl)(meth)acrylate moulding material, preferably a polymethyl (meth)acrylate moulding material or a polycarbonate moulding material.

Poly(alkyl)(meth)acrylate moulding materials are understood hereinafter to mean polymer moulding materials composed of polymerized (alkyl)methacrylate or composed of polymerized (alkyl)acrylate, and mixtures of the two monomer types.

Poly(alkyl)(meth)acrylates are generally obtained by free-radical polymerization of mixtures which comprise alkyl (meth)acrylates, preferably methyl (meth)acrylate. In general, these mixtures comprise at least 40% by weight, preferably at least 60% by weight and more preferably at least 80% by weight, based on the weight of the monomers, of alkyl (meth)acrylate.

Where polymethyl(meth)acrylates are concerned, mixtures for preparing them may comprise further (meth)acrylates which are copolymerizable with methyl methacrylate. The expression “(meth)acrylates” includes methacrylates and acrylates and mixtures of the two. These monomers are widely known. The (alkyl)(meth)acrylates, or (meth)acrylates for short, preferably include those which derive from saturated alcohols, for example methyl acrylate, ethyl (meth)acrylate, propyl(meth)acrylate, n-butyl (meth)acrylate, tert-butyl(meth)acrylate, pentyl (meth)acrylate and 2-ethylhexyl(meth)acrylate; (meth)acrylates which derive from unsaturated alcohols, for example oleyl (meth)acrylate, 2-propynyl (meth)acrylate, allyl (meth)acrylate, vinyl (meth)acrylate; aryl (meth)acrylates such as benzyl (meth)acrylate or phenyl (meth)acrylate, where the aryl radicals may each be unsubstituted or up to tetrasubstituted; cycloalkyl (meth)acrylates such as 3-vinylcyclohexyl (meth)acrylate, bornyl(meth)acrylate; hydroxylalkyl (meth)acrylates such as 3-hydroxypropyl (meth)acrylate, 3,4-dihydroxybutyl(meth)acrylate, 2-hydroxyethyl (meth)acrylate, 2-hydroxypropyl (meth)acrylate; glycol di(meth)acrylates such as 1,4-butanediol (meth)acrylate, (meth)acrylates of ether alcohols, such as tetrahydrofurfuryl (meth)acrylate, vinyloxy-ethoxyethyl (meth)acrylate; amides and nitriles of (meth)acrylic acid, such as N-(3-dimethylaminopropyl)-(meth)acrylamide, N-(diethylphosphono)(meth)acrylamide, 1-methacryloylamido-2-methyl-2-propanol; sulphur-containing methacrylates such as ethylsulphinylethyl (meth)acrylate, 4-thiocyanatobutyl (meth)acrylate, ethylsulphonylethyl (meth)acrylate, thiocyanatomethyl (meth)acrylate, methylsulphinylmethyl (meth)acrylate, bis((meth)acryloyloxyethyl)sulphide; polyfunctional (meth)acrylates such as trimethylolpropane tri(meth)acrylate.

In addition to the (meth)acrylates detailed above, the compositions to be polymerized may also comprise further unsaturated monomers which are copolymerizable with methyl methacrylate and the aforementioned (meth)acrylates.

These include 1-alkenes such as hexene-1, heptene-1; branched alkenes, for example vinylcyclohexane, 3,3-dimethyl-1-propene, 3-methyl-1-diisobutylene, 4-methyl-pentene-1; acrylonitrile; vinyl esters such as vinyl acetate; styrene, substituted styrenes with an alkyl substituent in the side chain, for example α-methylstyrene and α-ethylstyrene, substituted styrenes with an alkyl substituent on the ring, such as vinyltoluene and p-methylstyrene, halogenated styrenes, for example monochlorostyrenes, dichlorostyrenes, tribromostyrenes and tetrabromostyrenes; heterocyclic vinyl compounds such as 2-vinylpyridine, 3-vinyl-pyridine, 2-methyl-5-vinylpyridine, 3-ethyl-4-vinyl-pyridine, 2,3-dimethyl-5-vinylpyridine, vinyl-pyrimidine, vinylpiperidine, 9-vinylcarbazole, 3-vinyl-carbazole, 4-vinylcarbazole, 1-vinyl imidazole, 2-methyl-1-vinylimidazole, N-vinylpyrrolidone, 2-vinyl-pyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinyl-thiazoles and hydrogenated vinylthiazoles, vinyl-oxazoles and hydrogenated vinyloxazoles;

vinyl and isoprenyl ethers; maleic acid derivatives, for example maleic anhydride, methylmaleic anhydride, maleinimide, methylmaleinimide; and dienes, for example divinylbenzene.

In general, these comonomers are used in an amount of 0% by weight to 60% by weight, preferably 0% by weight to 40% by weight and more preferably 0% by weight to 20% by weight, based on the weight of the monomers, the compounds being useable individually or as a mixture. The polymerization is generally initiated with known free-radical initiators. The preferred initiators include the azo initiators widely known in the technical field, such as AIBN and 1,1-azobiscyclohexanecarbonitrile, and peroxy compounds such as methyl ethyl ketone peroxide, acetylacetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butyl peroxyisopropyl-carbonate, 2,5-bis(2-ethylhexanoylperoxy)-2,5-dimethyl-hexane, tert-butyl peroxy-2-ethylhexanoate, tert-butyl peroxy-3,5,5-trimethylhexanoate, dicumyl peroxide, 1,1-bis(tert-butylperoxy)cyclohexane, 1,1-bis(tert-butylperoxy)-3,3,5-trimethylcyclohexane, cumene hydroperoxide, tert-butyl hydroperoxide, bis(4-tert-butylcyclohexyl)peroxydicarbonate, mixtures of two or more of the aforementioned compounds with one another and mixtures of the aforementioned compounds with unspecified compounds which can likewise form free radicals.

These compounds are frequently used in an amount of 0.01% by weight to 10% by weight, preferably of 0.5% by weight to 3% by weight, based on the weight of the monomers.

It is possible here to use different poly(meth)acrylates which differ, for example, in terms of molecular weight or in terms of monomer composition.

It is also possible in accordance with the invention to colour impact-modified poly(meth)acrylate polymers.

In a first preferred embodiment, the impact-modified poly(meth)acrylate polymer consists of 20 to 80% and preferably 30 to 70% by weight of a poly(meth)acrylate matrix, and 80 to 20% and preferably 70 to 30% by weight of elastomer particles having a mean particle diameter of 10 to 150 nm (measurements, for example, by the ultracentrifuge method).

In a second preferred embodiment, in the polymethacrylate matrix, 1% by weight to 30% by weight, preferably 2% by weight to 20% by weight, more preferably 3% by weight to 15% by weight, especially 5% by weight to 12% by weight, of an impact modifier comprising an elastomer phase composed of crosslinked polymer particles is present.

The impact-modified poly(meth)acrylate polymer (imPMMA) consists of a proportion of matrix polymer and a proportion, distributed in the matrix, of impact modifiers based on crosslinked poly(meth)acrylates.

In the extruder, the impact modifier and matrix polymer can be mixed in the melt to form impact-modified polymethacrylate moulding materials. The material discharged is generally first cut into pellets. These pellets can be processed further by means of extrusion or injection moulding to give shaped bodies, such as slabs or injection mouldings.

The matrix polymer consists especially of 80% by weight to 100% by weight, preferably to an extent of 90% by weight—99.5% by weight, of free-radically polymerized methyl methacrylate units, and optionally to an extent of 0% by weight—20% by weight, preferably to an extent of 0.5% by weight—10% by weight, of further free-radically polymerizable comonomers, e.g. C₁- to C₄-alkyl (meth)acrylates, especially methyl acrylate, ethyl acrylate or butyl acrylate. The mean molecular weight M_{w} (weight average) of the matrix is preferably within the range from 90 000 g/mol to 200 000 g/mol, especially 100 000 g/mol to 150 000 g/mol (determination of M_{w} by means of gel permeation chromatography with reference to polymethyl methacrylate as the calibration standard). The molecular weight M_{w} can be determined, for example, by gel permeation chromatography or by a scattered light method (see, for example, H. F. Mark et al., Encyclopedia of Polymer Science and Engineering, 2nd Edition, Vol. 10, pages 1 ff., J. Wiley, 1989).

Preference is given to a copolymer composed of 90% by weight to 99.5% by weight of methyl methacrylate and 0.5% by weight to 10% by weight of methyl acrylate. The Vicat softening temperatures VET (ISO 306-B50) may be within the range of at least 90, preferably of 95, to 112° C.

Mixtures (blends) of thermoplastic polymers, especially of PMMA with further PMMA-compatible polymers, can likewise be used. Useful PMMA-compatible polymers include, for example, ABS polymers or SAN polymers.

The PMMA polymer moulding materials are traded under the PLEXIGLAS® brand by Evonik Röhm GmbH.

The polymethacrylate matrix comprises an impact modifier which may, for example, be an impact modifier of two- or three-shell structure.

Impact modifiers for polymethacrylate polymers are sufficiently well known. Preparation and structure of impact-modified polymethacrylate moulding materials are described, for example, in EP-A 0 113 924, EP-A 0 522 351, EP-A 0 465 049 and EP-A 0 683 028. Preferred preparation processes for impact modifiers are bead polymerization or emulsion polymerization.

In the simplest case, the impact modifiers are crosslinked particles which are obtainable by means of bead polymerization and have a mean particle size in the range from 10 to 150 nm, preferably 20 to 100 and especially 30 to 90 nm. These consist generally of at least 40% by weight, preferably 50% by weight-70% by weight, of methyl methacrylate, 20% by weight to 40% by weight, preferably 25% by weight to 35% by weight, of butyl acrylate, and 0.1% by weight to 2% by weight, preferably 0.5% by weight to 1% by weight, of a crosslinking monomer, for example a polyfunctional (meth)acrylate, for example allyl methacrylate, and optionally further monomers, for example 0% by weight to 10% by weight, preferably 0.5% by weight to 5% by weight, of C₁-C₄-alkyl methacrylates, such as ethyl acrylate or butyl methacrylate, preferably methyl acrylate, or other vinylically polymerizable monomers, for example styrene.

Preferred impact modifiers are polymer particles which may have a two-layer or a three-layer core-shell structure and are obtained by emulsion polymerization (see, for example, EP-A 0 113 924, EP-A 0 522 351, EP-A 0 465 049 and EP-A 0 683 028). Suitable particle sizes of these emulsion polymers must, however, for the purposes of the invention, be within the range of 10-150 nm, preferably 20 to 120 nm, more preferably 50-100 nm.

A three-layer or three-phase structure with a core and two shells may be configured as follows. An innermost (hard) shell may, for example, consist essentially of methyl methacrylate, minor proportions of comonomers, for example ethyl acrylate, and a crosslinker fraction, for example allyl methacrylate. The middle (soft) shell may be formed, for example, from butyl acrylate and optionally styrene, while the outermost (hard) shell usually corresponds essentially to the matrix polymer, which brings about compatibility and good attachment to the matrix. The polybutyl acrylate content in the impact modifier is crucial for the impact-modifying action and is preferably in the range from 20% by weight to 40% by weight, more preferably in the range from 25% by weight to 35% by weight.

In a preferred alternative with a two-layer structure, the elastomer particles distributed within the poly(meth)acrylate matrix have a core with a soft elastomer phase and a hard phase bound thereto.

Preferably, especially for film production, but not restricted thereto, a system known in principle from EP 0 528 196 A1 is used, which is a two-phase, impact-modified polymer composed of:
a1) 10 to 95% by weight of a continuous hard phase with a glass transition temperature T_{mg} above 70° C., composed of
a11) 80 to 100% by weight (based on a1) of methyl methacrylate and
a12) 0 to 20% by weight of one or more further ethylenically unsaturated, free-radically polymerizable monomers, and
a2) 90 to 5% by weight of a tough phase with a glass transition temperature T_{mg} below −10° C. distributed in the hard phase, and composed of
a21) 50 to 99.5% by weight of a C₁-C₁₀-alkyl acrylate (based on a2),
a22) 0.5 to 5% by weight of a crosslinking monomer having two or more ethylenically unsaturated, free-radically polymerizable radicals, and
a23) optionally further ethylenically unsaturated, free-radically polymerizable monomers,
   at least 15% by weight of the hard phase a1) being bonded covalently to the tough phase a2).

The two-phase impact modifier can be obtained by a two-stage emulsion polymerization in water, as described, for example, in DE-A 38 42 796. In the first stage, the tough phase a2) is obtained and is composed of lower alkyl acrylates to an extent of at least 50% by weight, preferably to an extent of more than 80% by weight, which gives rise to a glass transition temperature T_{mg} of this phase of below −10° C. The crosslinking monomers a22) used are (meth)acrylic esters of diols, for example ethylene glycol dimethacrylate or 1,4-butanediol dimethacrylate, aromatic compounds having two vinyl or allyl groups, for example divinylbenzene, or other crosslinkers having two ethylenically unsaturated, free-radically polymerizable radicals, for example allyl methacrylate as a graftlinker. Examples of crosslinkers having three or more unsaturated, free-radically polymerizable groups, such as allyl groups or (meth)acryloyl groups, include triallyl cyanurate, trimethylolpropane triacrylate and trimethacrylate, and pentaerythrityl tetraacrylate and tetramethacrylate. Further examples for this purpose are given in U.S. Pat. No. 4,513,118.

The ethylenically unsaturated, free-radically polymerizable monomers specified under a23) may, for example, be acrylic or methacrylic acid and their alkyl esters having 1-20 carbon atoms, provided that they have not yet been mentioned, where the alkyl radical may be linear, branched or cyclic. In addition, a23) may comprise further free-radically polymerizable aliphatic comonomers which are copolymerizable with the alkyl acrylates a21). However, significant fractions of aromatic comonomers such as styrene, alpha-methyl-styrene or vinyltoluene should remain excluded, since they lead to undesired properties of the moulding material A, in particular in the event of weathering.

In obtaining the tough phase in the first stage, the particle size and its polydispersity must be set carefully. The particle size of the tough phase depends essentially on the concentration of the emulsifier. Advantageously, the particle size can be controlled by the use of a seed latex. Particles having a mean particle size (weight-average) below 130 nm, preferably below 70 nm, and having a polydispersity U₈₀ below 0.5 (U₈₀ is calculated from an integral treatment of the particle size distribution which is determined by ultracentrifuge. U₈₀=[(r₉₀−r₁₀)/r₅₀]−1, where r₁₀, r₅₀, r₉₀=mean integral particle radius for which 10, 50, 90% of the particle radii are below and 90, 50, 10% of the particle radii are above this value) preferably below 0.2, are achieved with emulsifier concentrations of from 0.15 to 1.0% by weight based on the water phase. This is the case in particular for anionic emulsifiers, for example the particularly preferred alkoxylated and sulphated paraffins. The polymerization initiators used are, for example, from 0.01 to 0.5% by weight of alkali metal peroxodisulphate or ammonium peroxodisulphate, based on the water phase, and the polymerization is triggered at temperatures of from 20 to 100° C. Preference is given to using redox systems, for example a combination of from 0.01 to 0.05% by weight of organic hydroperoxide and from 0.05 to 0.15% by weight of sodium hydroxymethylsulphinate, at temperatures of from 20 to 80° C.

The hard phase a1) bonded covalently to the tough phase a2) at least to an extent of 15% by weight has a glass transition temperature of at least 70° C. and may be composed exclusively of methyl methacrylate. As comonomers a12), up to 20% by weight of one or more further ethylenically unsaturated, free-radically polymerizable monomers may be present in the hard phase, and alkyl (meth)acrylates, preferably alkyl acrylates having 1 to 4 carbon atoms, are used in such amounts that the glass transition temperature does not go below that mentioned above.

The polymerization of the hard phase a1) proceeds, in a second stage, likewise in emulsion using the customary assistants, as are also used, for example, for the polymerization of the tough phase a2).

In a preferred embodiment, the hard phase comprises low molecular weight and/or copolymerized UV absorbers in amounts of from 0.1 to 10% by weight, preferably from 0.5 to 5% by weight, based on A as a constituent of the comonomeric components a12) in the hard phase. Examples of polymerizable UV absorbers, as described, inter alia, in U.S. Pat. No. 4,576,870, include 2-(2′-hydroxyphenyl)-5-methacryloylamidobenzotriazole or 2-hydroxy-4-methacryloyloxybenzophenone. Low molecular weight UV absorbers may, for example, be derivatives of 2-hydroxybenzophenone or of 2-hydroxyphenylbenzo-triazole or phenyl salicylate. In general, the low molecular weight UV absorbers have a molecular weight of less than 2×10³ (g/mol). Particular preference is given to UV absorbers with low volatility at the processing temperature and homogeneous miscibility with the hard phase a1) of the polymer A.

The inventive colorant preparations can be used to colour the thermoplastic polymers mentioned above. However, it is also possible to colour mixtures (blends) of thermoplastic polymers, especially of PMMA with further PMMA-compatible polymers. Examples of polymers compatible with PMMA include ABS polymers or SAN polymers.

The PMMA polymer moulding materials are traded under the PLEXIGLAS° brand by Evonik Röhm GmbH.

It is additionally possible in accordance with the invention to colour polycarbonates. Polycarbonates are known in the technical field. Polycarbonates can be considered formally as polyesters formed from carbonic acid and aliphatic or aromatic dihydroxyl compounds. They are readily obtainable by reacting diglycols or bisphenols with phosgene or carbonic diesters, by polycondensation or transesterification reactions.

Preference is given in this context to polycarbonates which derive from bisphenols. These bisphenols include especially 2,2-bis(4-hydroxyphenyl)propane (bisphenol A), 2,2-bis(4-hydroxyphenyl)butane (bisphenol B), 1,1-bis(4-hydroxyphenyl)cyclohexane (bisphenol C), 2,2′-methylenediphenol (bisphenol F), 2,2-bis(3,5-dibromo-4-hydroxyphenyl)propane (tetrabromobisphenol A) and 2,2-bis(3,5-dimethyl-4-hydroxyphenyl)propane (tetramethylbisphenol A).

Typically, such aromatic polycarbonates are prepared by interfacial polycondensation or transesterification, details being given in Encycl. Polym. Sci. Engng. 11, 648-718.

In interfacial polycondensation, the bisphenols are emulsified as an aqueous, alkaline solution in inert organic solvents, for example methylene chloride, chlorobenzene or tetrahydrofuran, and reacted with phosgene in a stage reaction. The catalysts used are amines, and in the case of sterically hindered bisphenols also phase transfer catalysts. The resulting polymers are soluble in the organic solvents used.

The properties of the polymers can be varied widely through the selection of the bisphenols. In the case of simultaneous use of different bisphenols, it is also possible to form block polymers in multistage polycondensations.

### Test METHODS

### Determination of the TGA of the Anhydrous Dispersing Additives

The isothermal thermogravimetric analysis is effected by means of an auto TGA 2950 V 5.4 A thermal balance from TA Instruments with a heating rate of 5K/min up to 260° C. and subsequent isothermal analysis at 260° C. for 60 min. The samples are not conditioned before the analysis, but dried as follows:

The water-based dispersing additives are dried to constant mass in a drying oven before an analysis by TGA.

In the case of bead polymers as dispersing aids, the TGA is carried out on the solid bead polymer. In other words, in the case of an aqueous alkaline solution of the bead polymer, the solid bead polymer used to prepare this solution is analysed.

### Determination of Yellowness Index and of Transmission

Injection moulding was used to produce specimens of dimensions 60 mm×45 mm×3 mm, on which transmission (T) was determined to DIN 5036 and yellowness index (YI) to DIN 6167 with a lambda 19 measuring instrument from Perkin Elmer.

The particular coloured moulding materials were used to produce test specimens, or studies were conducted on the pellets. The test specimens were injection-moulded on an Arburg 221 or on a Battenfeld CD.

### Determination of Tensile Modulus

The modulus of elasticity was determined to ISO 527.

### Determination of Vicat Softening Temperature:

The Vicat softening temperature VET was determined to ISO 306-B50.

### Determination of Melt Volume Flow Rate MVR:

The melt volume flow rate MVR was determined to ISO 1133, 230° C./3.8 kg.

### Examination of Weatherability by Xenotest:

The weathering characteristics were assessed with reference to yellowness index and transmission changes, and also visual assessment after a 1500 h or 7500 h Xenotest. The instrument name is Xenotest 1200 (45 W/m²).

The examples which follow serve for further illustration and for better understanding of the present invention, but do not restrict it in any way.

### EXAMPLES

In the examples which follow, the dispersing additives A) Tego® Dispers 755W and B) bead copolymer of methacrylic acid with hydrophobic methacrylate and, in the comparative example, EFKA 4550 are used. The dispersing additives in the dried state have the following mass losses in isothermal thermogravimetric analysis at 260° C. for 60 min:
Example A: Tego® Dispers 755W=1.3% by weight
Example B: Copolymers of methacrylic acid with hydrophobic methacrylate=2.9% by weight
Comparative example V: EFKA 4550=25.5% by weight.
   I) Preparation of the Copolymer from Example B:

A polymerization vessel with hot water circuit, stirrer unit and nitrogen inlet is initially charged with a water phase consisting of:
750 kg of demineralized water
13.5 kg of 10% Mowiol in demineralized water
225 g of 2-mercaptoethanol diluted with 500 g of demineralized water
112 g of Trilon A (40% by weight solution of trisodium nitrilotriacetate in water, from BASF) further diluted with 500 g of water
3890 g of dibenzoyl peroxide, 75% by weight in water, slurried in 25 kg of demineralized water.

A monomer mixture of
169 kg of methacrylic acid
56.25 kg of 2-ethylhexyl methacrylate
   is pumped into this initial charge. Subsequently, 100 kg of demineralized water are added. The target temperature of the hot water circulation heating is set to 80° C. After the reaction has ended, the mixture is kept at 80° C. for another one hour, then cooled to 35° C., diluted with 450 kg of demineralized water and then screened through a Vibra screen (90 μm).

250 kg of the product obtained are mixed with 1500 kg of demineralized water in a polymerization vessel with a hot water circuit and stirrer unit, and heated to 60° C. Within 60 min, a mixture of
1100 kg of demineralized water
75 kg of 50% sodium hydroxide solution
   is added to this initial charge, and then 100 kg of demineralized water are added. Subsequently, the mixture is stirred at 60° C. for 4 hours, then cooled to 30° C., and the pH was adjusted with 50% sodium hydroxide solution to from 11.5 to 12.5. The dry content of the dispersing additive thus obtained is 3.5 to 4% by weight.

In order to test the effects of the dispersing additives on the yellowness index of a polymer mixture, uncoloured thermoplastic polymer moulding materials are subsequently first produced and subjected to a thermal stability test.

### II) Test of Thermal Stability of the Dispersing Additives:

The better thermal stability of the dispersing additives A) Tego® Dispers 755W and B) bead polymer dispersing additive compared to EFKA 4550 was assessed and demonstrated with reference to the yellowness index after thermal stress at different temperatures, shear and duration of the thermal stress. Two processes for thermal stress were compared:

### Process I: Compounding, Thermal Stress

### Injection Moulding T=290° C.

Process II: Thermal Stress by Brabender Kneading at T=260° C. with Variation of the Duration of the Thermal Stress and of the Concentration of the Dispersing Additive

### II.1) Process I: Compounding, Thermal Stress, Injection Moulding T=290° C.

The individual dispersing additives Tego® Dispers 755W (inventive examples A1 and A2) and EFKA 4550 (as comparative example V2) were compounded at 240° C. in the two concentrations of 0.01% by weight and 0.1% by weight, based in each case on PLEXIGLAS° 8N pellets, or, in the case of the bead polymer dispersing additive (approx. 4% by weight aqueous solution, inventive examples B1 and B2), of 0.25 and 1.5% by weight, and then the compound/pellets were injection-moulded at 290° C. The injection mouldings were used to produce impact-extruded sheets of thickness 3 mm at 210° C. For comparison, PLEXIGLAS® 8N pellets without dispersing additive were processed and thermally stressed in parallel (comparative example V1). The subsequently produced impact-extruded sheets are assessed visually for discoloration, deposit formation and pimple formation, and the yellowness index is measured. The reference material used with regard to yellowness index, colour and pimple formation is PLEXIGLAS 8N.

TABLE 1
Thermal stability tests on dispersing additives in
Plexiglas 8N moulding material without colorant

| | | | Vis. assessment | Yellow- |
|---|---|---|---|---|
| Exam- | Dispersing | Content | of the impact- | ness |
| ple | additive | [%] | extruded sheet | index |
| A1 | Tego ® | 0.01 | Clear, no | 0.6 |
| | Dispers | | discoloration, | |
| | 755W | | pimple-free | |
| A2 | Tego ® | 0.1 | Clear, no | 0.9 |
| | Dispers | | discoloration, | |
| | 755W | | pimple-free | |
| B1 | Bead | 0.25 | Slightly | 0.5 |
| | polymer | | cloudy, no | |
| | dispersing | | discoloration, | |
| | additive | | small pimples | |
| B2 | Bead | 1.5 | Slightly | 0.4 |
| | polymer | | cloudy, no | |
| | dispersing | | discoloration, | |
| | additive | | small pimples | |
| V1 | — | — | Clear | 0.6 |
| V2 | EFKA 4550 | 0.1 | Discoloration | 4.1 |

A comparison of the yellowness indices determined for comparative example V1 as the zero comparison with Examples A2, B2 and comparative example V2 makes it clear that the greatest increase in yellowness index is present for comparative example V2: +3.5 based on the zero value of V1=0.6.

11.2) Process II: Thermal Stress by Brabender Kneading, T=260° C., with Variation of the Duration of the Thermal Stress

In order to simulate thermal stress under shear, Brabender kneading tests were carried out under flowing argon at 260° C. The Brabender kneader is a Rheodrive 5000 recording kneader from HAAKE with a Rheomix 600 kneading attachment.

The base moulding material PLEXIGLAS® 8N was initially charged (50 g), and the appropriate amount, specified in Table 2, of dispersing additive was metered into the hot melt (0.019% by weight or 0.19% by weight). In addition to a kneading time of 10 min, kneading was also effected for 30 min in order to vary the duration of the thermal stress. The transmission and the yellowness index were determined on impact-extruded sheets (temperature in the production of the impact-extruded sheets 210° C.)

### 201000172 Foreign Countries

TABLE 2
Overview of the Brabender kneading tests at T = 260° C., kneading time 10 min

| | Example A3 | Example A4 | Example B3 | Example B4 | Comparative | Comparative | Comparative |
|---|---|---|---|---|---|---|---|
| | Tego ® | Tego ® | Bead polymer | Bead polymer | example V3 | example V4 | example V5 |
| | Dispers 755W | Dispers 755W | disp. ad. | disp. ad. | EFKA 4550 | EFKA 4550 | Water |
| | 0.019% by | 0.19% by | 0.019% by | 0.19% by | 0.019% by | 0.19% by | 0.019% by |
| | weight | weight | weight | weight | weight | weight | weight |
| Visual | transparent | transparent | transparent | slightly | slightly | yellow | transparent |
| assessment | | | | yellowish | yellowish | | |
| T [%] | 90.6 | 90.8 | 91.2 | 88.2 | 87.2 | 82.5 | 91.2 |
| Yellowness | 1.66 | 2.45 | 1.27 | 2.51 | 6.7 | 22.4 | 1.16 |
| index | | | | | | | |

The yellowness index of the impact-extruded sheet (IES) of Example A3 is only slightly higher than the yellowness index of the IES of V5 (comparative test only with addition of the corresponding amount of water, yellowness index 1.16): increase +0.5.

The yellowness index of the IES of Example B3 is only 1.27 after a stress time of 10 min at 260° C. For comparison, EFKA 4550 was examined: the yellowness index here is 6.7 (V3), and the transmission is only 87.2%. Considering greater use amounts of dispersing additive, the influence of the thermal instability of the dispersing additive EFKA 4550 becomes particularly clear. For instance, the IES of comparative example V4 attains a yellowness index of 22.4. The yellowness indices of the IESs of Examples A4 and B4 in comparison are only 2.45 and 2.51 respectively.

### 201000172 Foreign Countries

TABLE 3
Overview of the Brabender kneading tests at T = 260° C., kneading time 30 min

| | Example A5 | Example A6 | Example B5 | Example B6 | Comparative | Comparative |
|---|---|---|---|---|---|---|
| | Tego ® | Tego ® | Bead polymer | Bead polymer | example V6 | example V7 |
| | Dispers 755W | Dispers 755W | disp. add. | disp. add. | EFKA 4550 | EFKA 4550 |
| | 0.019% by | 0.19% by | 0.019% by | 0.19% by | 0.019% by | 0.19% by |
| | weight | weight | weight | weight | weight | weight |
| Visual | transparent | transparent | transparent | slightly | slightly | yellow |
| assessment | | | | yellowish | yellowish | |
| T [%] | 87.3 | 88.1 | 89.0 | 88.4 | 87.3 | 72.3 |
| Yellowness | 5.5 | 7.1 | 4.4 | 5.2 | 8.7 | 42.8 |
| index | | | | | | |

When the duration of thermal stress is increased from 10 min to 30 min, the yellowness indices of Examples A5 and B5 now likewise rise (5.5 and 4.4 respectively). At ten times the concentration, yellowness indices of 7.1 (Example A6) and 5.2 (Example B6) are now attained. The yellowness index of comparative example V7 rises to a very much higher degree in comparison (42.8).

### III) Test of Processability of the Colorant Preparations (for Deposit Formation)

### III.1) Production of Liquid Colour:

The particular dispersant (20 parts by weight), the demineralized water (40 parts by weight) and the two additives (Byk 024, 0.6 part by weight, and Ebotec MT15, 0.07 part by weight) are weighed into a glass bottle (125 ml). With the aid of a dissolver (Dispermat), the pigment (colorant 1: colorant 2=3.8:1) is stirred in portions into the liquid at 500-1000 rpm (approx. 20 min). After the stirring operation, the glass bottle is charged with 60 g of clay beads in each case, sealed to prevent leakage and dispersed on a roller bed for about 20 h. In order to assess the quality of the dispersion, the particle size was assessed thereafter with a grindometer.

TABLE 4
Overview of liquid colours produced

| | Example | Example | Comparative |
|---|---|---|---|
| | C1 | C2 | example V8 |
| Tego ® Dispers 755W | 20 | — | — |
| Bead polymer disp. ad. | — | 20 | — |
| EFKA 4550 | — | — | 20 |
| Demineralized water | 40 | 40 | 40 |
| Colorant 1 | 31.3 | 31.3 | 31.3 |
| Colorant 2 | 8.1 | 8.1 | 8.1 |
| Ebotec MT15 | 0.07 | 0.07 | 0.07 |
| Byk 024 | 0.6 | 0.6 | 0.6 |
| Grindometer | 5-50 | 5-50 | 5-50 |

### III.2) Colouring

Polymer pellets and colorant preparation were used to produce, in the tumbling mixer, a mixture which was metered by means of a funnel into the intake zone of a single-screw extruder. The venting zones were connected to a vacuum pump. The extruder had a downstream pelletizer.

In each case 0.057% by weight of the liquid colours C1, C2 and V8 produced as described above were applied by drum application to Plexiglas 8N moulding material pellets. The mixture was compounded twice on a single-screw extruder at 240° C. and, with regard to processibility, tested by injection moulding (100 pieces with closed barrel):

TABLE 5
Processibility of liquid colours

| | | Process- | Vicat |
|---|---|---|---|
| | Dispersant | ibility | temperature |
| Example C1 | Tego ® | No deposit | 107.9° C. |
| | Dispers 755W | formation, | |
| | | no streaks | |
| Example C2 | Bead polymer | No deposit | 109.9° C. |
| | dispersing | formation, | |
| | additive | no streaks | |
| Comparative | EFKA 4550 | No deposit | 109.15° C. |
| example V8 | | formation, | |
| | | no streaks | |

The results show that, on injection moulding of the thermoplastic polymer moulding material coloured with the inventive colorant preparation, no deposits form on the injection moulds. Compared to uncoloured PLEXIGLAS® 8N moulding material, after addition of the particular dispersing additives, the Vicat softening temperature increases from 106° C. to 109.15° C. or 109.9° C. or 107.9° C. (see Table 5).

IV) Colouring with Colorant Preparations Comprising Organic Binders (as Comparative Example V9)

For colouring with organic binder (fatty acid ester) formed from polymer pellets and colorant preparation, a mixture was produced in a tumbling mixer and was metered by means of a funnel into the intake zone of a single-screw extruder. The venting zones were connected to a vacuum pump. The extruder had a downstream pelletizer. The pellets thus obtained were used, in a second processing step, to injection-mould specimens for the Vicat softening temperature determination.

### Composition:

Colorant:
   0.06% by weight of Thermoplast Red® 454
   0.016% by weight of Macrolex Yellow® G
0.3% by weight of octadecenoic acid, present to an extent of approx. 70 mol % as oligoethylene glycol mono- and diester, remaining 30% esterified with sugar/sugar alcohols
99.62% by weight of PLEXIGLAS® 8N moulding material

Injection moulding on a Battenfeld BA 350CD:

Injection time: 1.76 sec

Melt temp.: 250° C.

Barrel temp.: 250 to 230° C.

Mould temp.: 68° C.

Switch from injection to hold pressure at internal mould pressure 560 bar

Total cycle time: 50 sec

Injection moulding with open venting barrel

After 30 shots, severe mould deposits and red colour fouling

Vicat softening temperature: 106° C.

For comparison:

Vicat softening temperature of the PLEXIGLAS® 8N moulding material with 0.06% by weight of Thermoplast Red® 454 and 0.016% by weight of Macrolex Yellow® G without C18 fatty acid: 107° C.

### V) Comparison of the Properties of the Products Produced by Means of a Continuous Colouring Operation

Colourings based on the EFKA 4550 dispersing additive were often found to be too yellow with regard to the colour locus, i.e. the colour locus was well above the ellipse which can otherwise be attained using the colorant ratio used for standard compounding.

The advantage in this regard of using the dispersing additive A) Tego® Dispers 755W is demonstrated by the test which follows, analogously to Example 1 from the application text of DE102009045122.6. A system according to FIG. 1 and the description of DE102009045122.6 was employed. The injection valve used was an injection valve with bellows, type 230 DN2, PN from Phönix. The pressure within the extruder at the injection site corresponded approximately to atmospheric pressure, and the temperature was approx. 260° C. At the inlet site, 750 kg per hour of moulding material were passed through. The aqueous liquid colours used were the following compositions:

TABLE 6
Compositions of liquid colours of the production tests,
D1 having a colorant content of 20% by weight,
D2 a colorant content of 33% by weight, and
V10 a colorant content of 40% by weight.

| | | | Comparative |
|---|---|---|---|
| | Example D1 | Example D2 | example V10 |
| Liquid colour | [% by wt.] | [% by wt.] | [% by wt.] |
| Dispersing | 20 | 30 | — |
| additive Tego ® | | | |
| Dispers 755W | | | |
| Dispersing additive | — | — | 20 |
| EFKA 4550 | | | |
| Demineralized | 59.33 | 36.33 | 39.33 |
| water | | | |
| Thermoplast Red 454 | 15.87 | 24.41 | 31.74 |
| Macrolex Yellow G | 4.13 | 8.59 | 8.26 |
| Byk 024 (defoamer) | 0.6 | 0.6 | 0.6 |
| Ebotec MT 15 | 0.07 | 0.07 | 0.07 |
| (antibactericide) | | | |

The supply of the amount of liquid colour D1 or D2 and V10 needed in each case to produce the desired coloured moulding material was controlled with the arrangement detailed in FIG. 1 of DE102009045122.6.

The coloured moulding material exhibited excellent colour distribution, which remained within very narrow colour specifications.

To describe the colour, the standard valence system (DIN 5033, part 3) with x, y coordinates and light transmission was used, and these values were determined to DIN 5033, parts 4 and 7.

Customary specifications of the coloured moulding material stipulate an X coordinate in the range from 0.6495 to 0.6565, a Y coordinate in the range from 0.3335 to 0.3360 and a transmission in the range from 30.8 to 32.8%. Over the entire test duration of approx. 3 h, three samples were taken at constant time intervals from each of the production tests with D1 and D2. In the production test with V10, 5 samples were taken within the test time of 3 h.

TABLE 7
Overview of the results of the production tests based on
X and Y coordinates or transmission in comparison
to the customary product specification of these values

| | D1 | D2 | V10 |
|---|---|---|---|
| Max. value of the X | approx. | approx. | 0.6612 |
| coordinate | 0.6555 | 0.6530 | |
| Min. value of the X | approx. | approx. | 0.6553 |
| coordinate | 0.654 | 0.6505 | |
| Max. value of the Y | approx. | approx. | 0.3361 |
| coordinate | 0.3353 | 0.336 | |
| Min. value of the Y | approx. | approx. | 0.3333 |
| coordinate | 0.3346 | 0.3358 | |
| Max. value of | 32.4 | 32.5 | 31.7 |
| transmission [%] | | | |
| Min. value of | 31.9 | 32.2 | 30.5 |
| transmission [%] | | | |

While use of V10 resulted in attainment of values outside the product specification range, the values using D1 or D2 are within the product specification range.

### VI) Weathering on Moulding Material

### VI.1) Non-Coloured Moulding Material Comprising the Dispersant Additive Tego® Dispers 755W for Testing of the Pure Dispersing Additive

Advantageously, the addition of the dispersing additive Tego® Dispers 755W does not have an adverse effect on the weathering characteristics. After a Xenotest for 5000 h and 7500 h (sample thickness 3 mm, illuminant) D65/10°, Plexiglas 8N containing 0.1% by weight of Tego® Dispers 755W was compared with glass-clear Plexiglas 8N with regard to the change in transmission and in the yellowness index. In addition, the samples were assessed visually. The amount of Tego-Dispers used is significantly increased compared to the otherwise customary liquid colour compositions, in order to be able to identify the possible influence of the dispersing additive on the weathering characteristics.

TABLE 8
Xenotest results after 5000 h of Xenotest weathering

| | Δ trans- | Δ yellowness | Visual |
|---|---|---|---|
| Sample | mission | index | assessment |
| Plexiglas 8N | −0.63 | +0.47 | Slightly |
| | | (from 0.35 | darkened, |
| | | to 0.82) | slight |
| | | | yellowing |
| Plexiglas 8N | −0.26 | +0.36 | Slightly |
| +0.1% by | | (from 0.56 | darkened, |
| wt. of Tego ® | | to 0.92) | slight |
| Dispers 755W | | | yellowing |

TABLE 9
Xenotest results after 7500 h of Xenotest weathering

| | | Δ yellowness | Visual |
|---|---|---|---|
| | Δ transmission | index | assessment |
| | (7500 h | (7500 h | (7500 h |
| Sample | Xenotest) | Xenotest) | Xenotest) |
| Plexiglas 8N | −0.62 | +0.57 | Slightly |
| | | (from 0.35 | darkened, |
| | | to 0.92) | slight |
| | | | yellowing |
| Plexiglas 8N | −0.39 | +0.38 | Slightly |
| +0.1% by | | (from 0.56 | darkened, |
| wt. of | | to 0.94) | slight |
| Dispers 755W | | | yellowing |

The Plexiglas 8N which has been doped with dispersing additive exhibited, after 7500 h, a change in yellowness index and transmission comparable to pure Plexiglas 8N.

### VI.2) Weathering on Red-Coloured Moulding Material Comprising Colorant and the Dispersing Additive Tego® Dispers 755W to Test the Combination of Colorant and Binder

Specimens produced from material of the test with D1 (Plexiglas 8N red) exhibited, in comparison with a correspondingly coloured standard product produced by addition of masterbatch (Plexiglas 8N red), comparable weathering characteristics:

TABLE 10
Xenotest results after 1500 h of Xenotest weathering
on coloured Plexiglas (Plexiglas 8N red)

| | Δ | | | Visual |
|---|---|---|---|---|
| | transmission | Δx | Δy | assessment |
| | (1500 h | (1500 h | (1500 h | (1500 h |
| Sample | Xenotest) | Xenotest) | Xenotest) | Xenotest) |
| Plexiglas | 0.45 | −0.0024 | 0.0009 | Barely |
| 8N red | | | | perceptible |
| Standard | | | | darkening |
| Plexiglas | 0.35 | −0.0019 | 0.0005 | Barely |
| 8N red D1 | | | | perceptible |
| | | | | darkening |

### VI.2.1) Processibility:

Plexiglas 8N red (material from D1) exhibits, even after 100 shots from an Arburg 221 injection moulding machine with closed barrel, no deposit formation or any other peculiarities.

### VI.2.2) Results of the Mechanical Tests

Vicat softening temperature, melt volume flow rate MVR and, in the tensile test, the modulus of elasticity were determined on the particular specimens.

TABLE 11
Mechanical properties

| | Plexiglas | Plexiglas | Plexiglas | |
|---|---|---|---|---|
| | 8N red | 8N red | 8N red | |
| Feature | Standard | from D1 | from D2 | Unit |
| Vicat | 108.6 | 107.9 | 107.1 | ° C. |
| Ökovicat, | | | | |
| B50 | | | | |
| MVR 230° C., | 2.9 | 3.1 | 3.2 | cm³/10 min |
| 3.8 kg | | | | |
| Modulus of | 3500 | 3500 | 3500 | MPa |
| elasticity | | | | |
| 1 mm/min, | | | | |
| ISO 527 | | | | |

It is evident from the mechanical values of the red-coloured moulding materials that the product properties of a standard material produced with a masterbatch do not differ from the product properties of a material coloured with Tego® 755W-based liquid colour.

### VII) Demonstration of the Stabilization of a Colorant Preparation by Means of an Inventive Thickener

In the prior art, more particularly WO 2010/020474 A1, the dispersing additive used was EFKA 4550. With this additive it is possible to achieve the formulation viscosities necessary for good processing at dye contents of, for example, 33.33% by weight. The disadvantage of the EFKA 4550 lies in its low thermal stability, which can easily lead to partial overheating of the active ingredient in the course of production of the formulation. This then becomes perceptible in a rise in viscosity over the storage time, which can lead to difficulties in the processing. In addition, it is not possible with EFKA 4550 to produce formulations which have a dye content of 6% and a sufficiently high viscosity for the application.

With the inventive colorant preparations, in contrast, viscosity problems in the course of storage can be avoided. In addition, it is also possible to produce formulations with a low dye content and hence to make available other colours. Addition of a thickener in the inventive system allows synergistic effects with the dispersing additive to be achieved, such that, in addition to the avoidance of viscosity problems, it is also possible to improve the sedimentation characteristics. This is demonstrated by the examples and comparative examples summarized in Table 12. Colorant preparations are produced according to the formulations in Table 12, and the viscosity thereof or the sedimentation rate is determined.

TABLE 12

| Comparative Example | | Comparative Example | | Example | | Example | |
|---|---|---|---|---|---|---|---|
| V11 | | V12 | | I1 | | I2 | |
| % by wt. | Constituent | % by wt. | Constituent | % by wt. | Constituent | % by wt. | Constituent |
| 16.67 | EFKA 4550 | 16.67 | EFKA 4550 | 8.33 | Tego Dispers | 8.34 | Tego Dispers |
| | | | | | 755 W | | 755 W |
| 0.50 | Byk 024 | 0.50 | Byk 024 | 0.50 | Byk 024 | 0.50 | Byk 024 |
| 33.33 | dye | 6.00 | dye | 33.33 | dye | 6.00 | dye |
| 0.41 | Preservative | 0.41 | Preservative | 0.41 | Preservative | 0.41 | Preservative |
| — | Thickener | — | Thickener | 8.17 | Rohagit hv | 28.34 | Rohagit hv |
| | | | | | 5% stock | | 5% stock |
| | | | | | solution | | solution |
| 49.09 | DM water | 76.42 | DM water | 49.26 | DM water | 56.41 | DM water |

Viscometry studies

| Viscosity | Shear rate | Viscosity | Shear rate | Viscosity | Shear rate | Viscosity | Shear rate |
|---|---|---|---|---|---|---|---|
| [mPas] | [1/s] | [mPas] | [1/s] | [mPas] | [1/s] | [mPas] | [1/s] |
| 2190 | 1 | 3.9 | 1 | 2400 | 1 | 916 | 1 |
| 460 | 10 | 1.2 | 10 | 519 | 10 | 569 | 10 |
| 152 | 100 | 1.39 | 100 | 167 | 100 | 251 | 100 |

Sedimentation rate determined as the migration rate
of the phase boundary in the Lumifuge spectrum

| | | | |
|---|---|---|---|
| 0.6545 μm/s | 0.8947 μm/s | 0.3285 μm/s | 0.4821 μm/s |

It is clearly evident in Table 12 that the sedimentation rate in the inventive system with the same dye content is about half as fast as with the prior art system. In addition, it can be inferred from the viscosity values that only with the inventive system are low dye contents producible at usable viscosities.

After colouring a moulding material, the polymer used for thickening remains in the moulding material and does not have an adverse effect on the properties thereof. This was checked by the determination of the thermal stability and of the weathering results of moulding materials comprising Rohagit S hv.

For this purpose, the thermal stability of the thickener Rohagit S hv was tested by a blend of Plexiglas® 8N moulding material with 0.01% Rohagit S hv by a thermal stability test at 290° C. In each case 0.01% of thickener was introduced by compounding, and then the compound/pellets was/were injection-moulded at 290° C. The injection mouldings were used to produce impact-extruded sheets of thickness 3 mm at 210° C. The yellowness index of the moulding material comprising the thickener was 0.7.

The thermal stability of the thickener Rohagit S my was likewise tested by a blend of Plexiglas® 8N moulding material with 0.01% Rohagit S mV in a thermal stability test at 290° C. The yellowness index of the moulding material comprising the thickener was 0.8.

The Xeno test on a red-coloured Plexiglas® 8N moulding material comprising a methacrylic acid copolymer corresponding to Rohagit S, after 10 000 h (sample thickness 3 mm, illuminant A/2°), just as in the case of the Plexiglas® 8N comparative moulding material without thickener polymer, did not lead to any crack formation.

1. An aqueous colorant preparation, comprising:
a) from 1% to 49% by weight of a dispersing additive having a mass loss in dried form of not more than 15% by weight, in isothermal thermogravimetric analysis at 260° C. for 60 min;
b) from 0.5% to 50% by weight of a pigment or of a pigment mixture;
c) from 0% to 50% by weight of an assistant; and
d) from 0% to 98.5% by weight of water,
wherein the portions by weight of components a) to d) add up to 100% by weight, and the pigment b) is at least one selected from the group consisting of a diazo dye, perylene, an anthraquinone, an anthrapyrimidine, perinone, Thermoplast Red® 454, Macrolex Yellow® G, zinc chromate, cadmium sulphide, chromium oxide, an ultramarine pigment, a metal flake, BaSO₄, Sandoplast® Red G, and Solvaperm® Red G.

2. The aqueous colorant preparation of claim 1, wherein the proportion of the dispersing additive is between 5% to 45% by weight, based on the total amount of the colorant preparation.

3. The aqueous colorant preparation of claim 1, wherein the dispersing additive is a high molecular weight copolymer comprising maleic anhydride, styrene, and an amino polyether as monomer units.

4. The aqueous colorant preparation of claim 1, wherein the dispersing additive is a copolymer of methacrylic acid with hydrophobic methacrylate.

5. The aqueous colorant preparation of claim 1, wherein the dispersing additive is a copolymer of a polyether, and a styrene oxide.

6. The aqueous colorant preparation of claim 1, wherein the assistant is present, and is a thickener.

7-14. (canceled)

15. The aqueous colorant preparation of claim 1, wherein the pigment
b) is Sandoplast® Red G or Solvaperm® Red G.

16. A process for colouring a thermoplastic polymer moulding material, the process comprising:
mixing a thermoplastic polymer moulding material with the aqueous colorant preparation of claim 1.

17. A thermoplastic polymer, comprising the aqueous colorant preparation of claim 1.

18. A poly(alkyl)(meth)acrylate material, comprising the aqueous colorant preparation of claim 1.

19. A process for colouring a thermoplastic polymer, the process comprising:
mixing a thermoplastic polymer with the aqueous colorant preparation of claim 1.

20. The process of claim 19, wherein the thermoplastic polymer is a poly(alkyl)(meth)acrylate.

21. The process of claim 19, wherein the thermoplastic polymer is an impact-modified poly(alkyl)(meth)acrylate.

22. A thermoplastic polymer moulding material obtained by the process of claim 19.

23. A polymer moulding produced by injection moulding or extrusion of the thermoplastic polymer moulding material of claim 22.

24. The aqueous colorant preparation of claim 5, wherein the polyether is at least one selected from the group of ethylene oxide, propylene oxide, butylene oxide, or any mixture thereof.
